(19) United States
(12) Patent Application Publication
(10) Pub. No.: US 2018/0018095 A1
(43) Pub. Date: Jan. 18, 2018

(54) METHOD OF OPERATING STORAGE DEVICE AND METHOD OF OPERATING DATA PROCESSING SYSTEM INCLUDING THE DEVICE

(71) Applicant: Samsung Electronics Co., Ltd., Suwon-si (KR)

(72) Inventors: Jeong Ho LEE, Gwacheon-si (KR); Jin Woo KIM, Seoul (KR); Young Jin CHO, Seoul (KR)

(73) Assignee: Samsung Electronics Co., Ltd., Suwon-si (KR)

(21) Appl. No.: 15/641,576

(22) Filed: Jul. 5, 2017

(30) Foreign Application Priority Data
Jul. 18, 2016 (KR) 10-2016-0090864

(51) Int. Cl. G06F 3/06

(52) U.S. Cl. CPC G06F 3/0604; G06F 12/1009; G06F 3/0619; G06F 12/1036; G06F 3/0611; G06F 3/0685; G06F 3/065; G06F 2212/65; G06F 2212/68

(57) ABSTRACT

A method of operating a data storage device which includes a first memory device, a second memory device, and a memory device storing a translation map is provided. The method includes receiving either a first identifier (ID) or a second ID and a virtual address from a host, selecting one of a first physical address and a second physical address from the translation map using either the first ID or the second ID and the virtual address, and reading data from one of the first memory device and the second memory device using the selected physical address and transmitting the data to the host. The translation map includes information about mapping the first ID and the virtual address to the first physical address of the first memory device and information about mapping the second ID and the virtual address to the second physical address of the second memory device.

### CROSS-REFERENCE TO RELATED APPLICATION

This U.S. non-provisional application claims the benefit of priority under 35 U.S.C. §119(a) from Korean Patent Application No. 10-2016-0090864, filed on Jul. 18, 2016, in the Korean Intellectual Property Office (KIPO), the entire disclosure of which is hereby incorporated by reference in its entirety.

### BACKGROUND

Various example embodiments of the inventive concepts relate to a data storage device, a method of operating the data storage device, and/or a data processing system including the data storage device. More particularly, some example embodiments of the inventive concepts relate to a data storage device which includes heterogeneous memory devices (e.g., a plurality of memory devices that are not of the same type) accessible using a virtual address and a processor identifier (ID), a method of operating the data storage device, and/or a data processing system including the data storage device.

A memory device transmits data to a host, or writes data transmitted from the host, using a physical address received from the host. The host performs an operation of translating a virtual address into a physical address to access the memory device. This translation operation increases the complexity of an operating system (OS) and a memory management system (e.g., a memory management unit (MMU) or a translation lookaside buffer (TLB)).

The memory management system performs memory allocation and de-allocation for each process, translates a virtual address into a physical address, and accesses a memory device using the physical address. The memory management system requires a very large page map for these operations. In addition, there is undesirable overhead when a virtual address is translated into a physical address using the memory management system.

### SUMMARY

According to some example embodiments of the inventive concepts, there is provided a method of operating a data storage device which includes a first memory device, a second memory device, and a third memory device storing a translation map. The method includes receiving, an identifier and a virtual address from a host, the identifier being one of a first ID and a second ID, selecting one of a first physical address and a second physical address using the translation map based on the received identifier and the virtual address, the translation map including first information related to a mapping of the first ID and the virtual address to the first physical address of the first memory device, and second information about a mapping of the second ID and the virtual address to the second physical address of the second memory device, reading data from one of the first memory device and the second memory device based on the selected physical address, and transmitting the read data to the host.

According to other example embodiments of the inventive concepts, there is provided a method of operating a data storage device which includes a first memory device and a second memory device. The method includes receiving a first identifier (ID) and a virtual address from a host, translating the first ID and the virtual address into a first physical address, and accessing at least one of the first memory device and the second memory device based on the first physical address.

According to further example embodiments of the inventive concepts, there is provided a method of operating a data processing system which includes a data storage device including a first memory device and a second memory device and a host controlling the data storage device. The method includes receiving, using the data storage device, a first identifier (ID) and a virtual address from the host, translating, using the data storage device, the first ID and the virtual address into a first physical address associated with the first memory device or the second memory device, reading, using the data storage device, first data from the memory device associated with the first physical address, and transmitting the read first data to the host.

According to another example embodiment of the inventive concepts, there is provided a method for operating a data storage device, the data storage device including a plurality of heterogeneous memory devices and a memory controller. The method includes receiving, using the memory controller, a memory operation instruction from a host, the memory operation including at least a process ID and a virtual address, translating, using the memory controller, the virtual address into a physical address associated with a memory device of the plurality of heterogeneous memory devices using a virtual address-to-physical address translation map stored on a buffer and the process ID, and performing, using the memory controller, a memory operation at the physical address on the associated memory device in accordance with the memory operation instruction.

### BRIEF DESCRIPTION OF THE DRAWINGS

The above and other features and advantages of the inventive concepts will become more apparent by describing in detail example embodiments thereof with reference to the attached drawings in which:

FIG. 1 is a block diagram of a data processing system including a data storage device which runs a memory management unit according to some example embodiments of the inventive concepts;

FIG. 2 is a block diagram of a data processing system including a data storage device which runs a memory management unit according to other example embodiments of the inventive concepts;

FIG. 3 is a diagram of data stored in a cache illustrated in FIG. 1 or 2, according to some example embodiments of the inventive concepts;

FIG. 4 is a diagram of a virtual address-to-physical address translation map stored in memory illustrated in FIG. 1 or 2 according to some example embodiments of the inventive concepts;

FIG. 5 is a diagram of a virtual address-to-physical address translation map stored in memory illustrated in FIG. 1 or 2 according to other example embodiments of the inventive concepts;

FIG. 6 is a flowchart of a read operation of the data storage device illustrated in FIG. 1 or 2 according to some example embodiments of the inventive concepts;

FIG. 7 is a flowchart of a read operation of the data storage device illustrated in FIG. 1 or 2 according to other example embodiments of the inventive concepts;

FIG. 8 is a flowchart of a write operation of the data storage device illustrated in FIG. 1 or 2 according to some example embodiments of the inventive concepts;

FIG. 9 is a flowchart of a write operation of the data storage device illustrated in FIG. 1 or 2 according to other example embodiments of the inventive concepts;

FIG. 10 is a conceptual diagram of the memory management of the data storage device illustrated in FIG. 1 or 2 according to some example embodiments of the inventive concepts;

FIG. 11 is a conceptual diagram of the memory management of the data storage device illustrated in FIG. 1 or 2 according to other example embodiments of the inventive concepts;

FIG. 12 is a conceptual diagram for explaining hierarchical memory shift in accordance with a data usage level for locality, according to some example embodiments of the inventive concepts;

FIG. 13 is a conceptual diagram for explaining context switching according to some example embodiments of the inventive concepts; and

FIG. 14 is a conceptual diagram of the operation of the data processing system, illustrated in FIG. 1 or 2, which performs the context switching illustrated in FIG. 13, according to some example embodiments of the inventive concepts.

### DETAILED DESCRIPTION

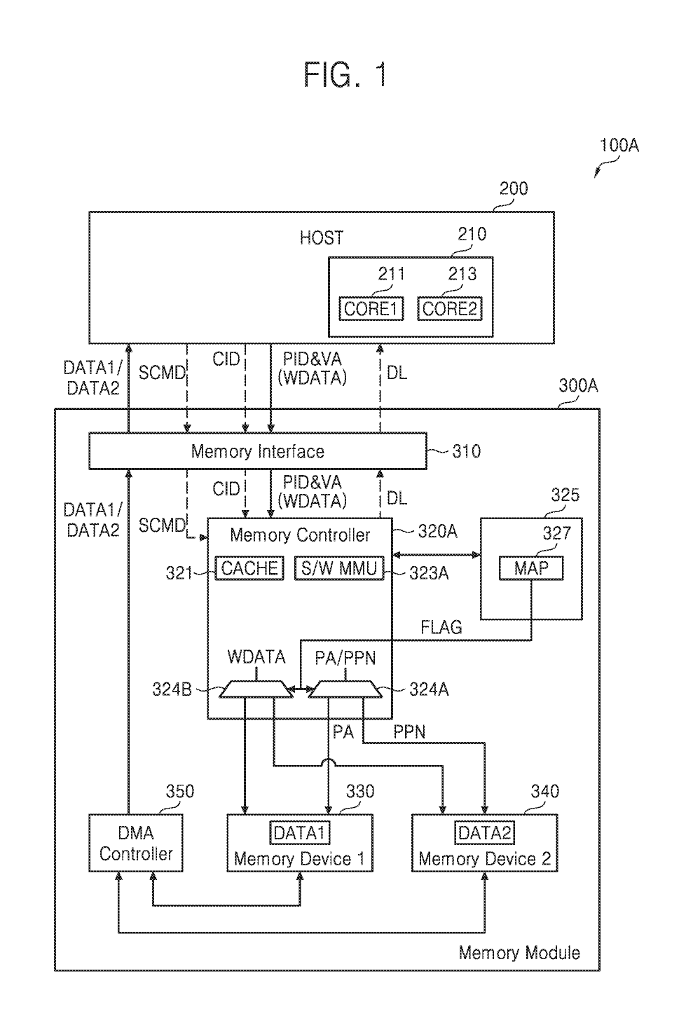

FIG. 1 is a block diagram of a data processing system including a data storage device which runs a memory management unit according to some example embodiments of the inventive concepts. The data processing system 100A may include a host 200 and the data storage device 300A, but is not limited thereto.

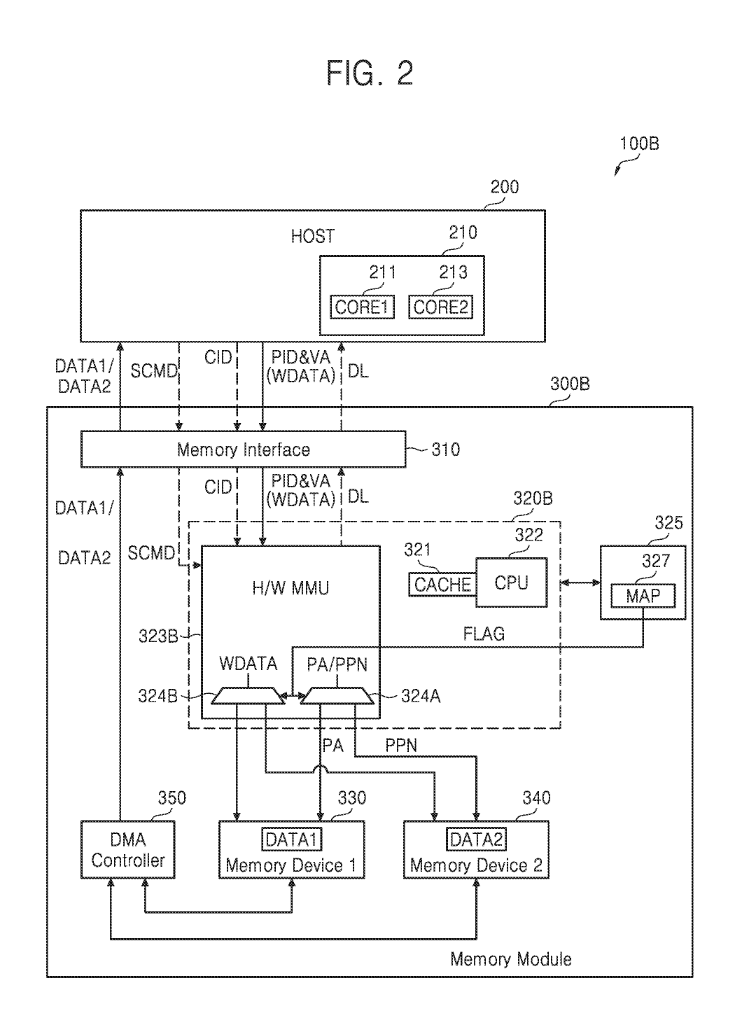

The data processing system 100A or 100B (as illustrated in FIG. 2 and will be described below), may be a personal computer (PC), a mobile computing device, a server, and/or other processing device. The data processing system 100A may be used in a data center, a clouding computing system, etc. The data processing system may also be a laptop computer, a smart phone, a tablet PC, a personal digital assistant (PDA), an enterprise digital assistant (EDA), a digital still camera, a digital video camera, a portable multimedia player (PMP), a personal navigation device or portable navigation device (PND), a game console, a handheld game console, a mobile internet device (MID), a wearable computer and/or device, an internet of things (IoT) device, an internet of everything (IoE) device, a drone, a smart device, a virtual reality device, an augmented reality device, etc.

The host 200, which includes at least one processor 210, may be a computing device which can control data access and/or memory operations (e.g., a write operation and/or a read operation) of the data storage device, such as data storage device 300A and/or 300B (illustrated in FIG. 2). The processor 210 may be implemented as a multi-core processor, a multi-processor system, a distributed processor system, etc. The processor 210 may include two cores 211 and 213, as shown in FIGS. 1 and 2, but the number of cores formed in the processor 210 may vary with other example embodiments.

During a read operation, the data storage device, e.g., 300A or 300B, etc., may read data, such as DATA1 or DATA2, stored in one of heterogeneous memory devices 330 and/or 340 using a process identifier (ID) PID and a virtual address VA, which are provided by the host 200, and may transmit the data, e.g., DATA1 or DATA2, to the host 200. Here, the process ID PID is a number used by the kernel of an operating system (OS) to identify a process which has been activated. In other words, the process ID PID is an ID for identifying a process executed by the processor 210 of the host 200. For example, a first process ID or a second process ID may be an ID of a first process or a second process executed by a first processor. The process, e.g., the first process or the second process, may be a process associated with any software application executable by the OS, such as an image viewing process, a video playback process, an internet browsing process, etc.

During a write operation, the data storage device 300A or 300B may write data WDATA to at least one of the heterogeneous memory devices 330 and 340 using the process ID PID, the virtual address VA, and the data WDATA, which have been provided by the host 200. Each time the processor 210 sends a memory access request (e.g. a memory access request and/or instruction for a read or write operation) to the memory device 330 or 340, the data storage device 300A or 300B may translate the process ID PID and the virtual address VA into a physical address (PA) or physical page number (PPN), and access the memory device 330 or 340 using the physical address PA or physical page number PPN.

For example, the data storage device 300A or 300B may translate a combination of the process ID PID and the virtual address VA into the physical address PA or physical page number PPN and may access the memory device 330 or 340 using the physical address PA or physical page number PPN according to at least one example embodiment.

When a memory device, such as the second memory device 340, is NAND flash memory, the virtual address may be a virtual page number (VPN) and the physical address may be a physical page number (PPN). Conventionally, a host performs virtual address-to-physical address translation, either in the OS of the host or in specialized circuitry of the host, such as a memory management unit (MMU) or a translation lookaside buffer (TLB). However, according to some example embodiments of the inventive concepts, the data storage device, e.g., 300A or 300B, may receive the process ID PID and the virtual address VA instead of a physical address associated with the memory access request, and may translate the process ID PID and the virtual address VA into the physical address PA or physical page number PPN. In other words, in various example embodiments, the data storage device may perform the virtual address to physical address translation instead of the host, thereby reducing the overhead of the host.

The data storage device 300A or 300B may be implemented as a memory module which includes the heterogeneous memory devices 330 and 340, but is not limited thereto. For example, the data storage device may include a greater or lesser number of memory devices according to other example embodiments. The memory module 300A or 300B may be implemented as a dual in-line memory module (DIMM), but the inventive concepts are not restricted to the current example embodiments and may be any type of memory module, such as a single in-line memory module (SIMM), a single in-line package (SIP), a zig-zag in-line package (ZIP), etc. Various types of data storage devices, such as solid state drives (SSDs), etc., may be used as the memory modules, e.g., 300A or 300B.

The data storage device 300A may include a memory interface (e.g., a DIMM interface) 310, a memory controller 320A, a buffer memory device 325, the first memory device 330, the second memory device 340, and a direct memory access (DMA) controller 350, but is not limited thereto.

The data storage device 300A may communicate signals and data with the host 200 through the memory interface 310. For the read operation of the data storage device 300A, the process ID PID and the virtual address VA provided by the host 200 may be transmitted to the memory controller 320A through the memory interface 310.

The memory interface 310 may include at least one dedicated pin for receiving at least one of the process ID PID and the virtual address VA. The memory interface 310 may include pins newly defined to receive the process ID PID and/or the virtual address VA. The process ID PID and the virtual address VA may be transmitted in parallel or in a packetized form.

The memory controller 320A may receive the process ID PID and the virtual address VA and may translate the process ID PID and the virtual address VA into the physical address PA or physical page number PPN using (or referring to) a virtual address-to-physical address translation map 327 stored in the buffer memory device 325. The memory controller 320A may be a central processing unit (CPU), application-specific integrated circuit (ASIC), a field programmable gate array (FPGA), or other processing device or integrated circuit, which includes at least one core. The memory controller 320A may read out the virtual address-to-physical address translation map 327 from the buffer memory device 325.

The memory controller 320A may include a cache 321, a first selector circuit 324A, and a second selector circuit 324B, and may execute a software memory management unit (S/W MMU) 323A, but is not limited thereto. The S/W MMU 323A may be loaded from the second memory device 340 to the memory controller 320A at the time of boot-up. Each of the selector circuits 324A and 324B may be implemented as a demultiplexer, but are not limited thereto.

FIG. 2 is a block diagram of the data processing system including the data storage device which runs a memory management unit according to other example embodiments of the inventive concepts. The data processing system 100B may include the host 200 and the data storage device 300B, but is not limited thereto.

The data storage device 300B may include the memory interface (e.g., a DIMM interface) 310, a memory controller 320B, the buffer memory device 325, the first memory device 330, the second memory device 340, and the DMA controller 350, etc. The memory controller 320B may include the cache 321, a CPU 322, a hardware memory management unit (H/W MMU) 323B, etc. The H/W MMU 323B may include the first selector circuit 324A and the second selector circuit 324B, etc.

In some example embodiments of the inventive concepts, an MMU may be implemented as the S/W MMU 323A executed by the memory controller 320A or as the H/W MMU 323B included in the memory controller 320B. While the selector circuits 324A and 324B are included in the memory controller 320A in the example embodiment illustrated in FIG. 1, the selector circuits 324A and 324B are included in the H/W MMU 323B in the example embodiment illustrated in FIG. 2. The CPU 322 may control the overall operation of the memory controller 320B. In particular, the CPU 322 may control the operations of the cache 321 and the H/W MMU 323B. The function of the S/W MMU 323A is the same as that of the H/W MMU 323B.

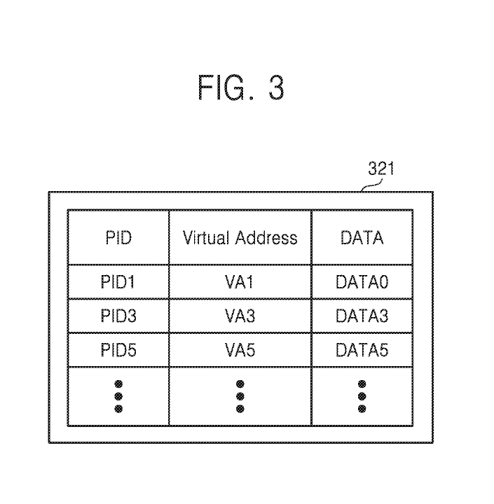

FIG. 3 is a diagram of data stored in the cache illustrated in FIG. 1 or 2 according to some example embodiments. The cache 321 may be a virtual cache, or a physical cache, and may be implemented as static random access memory (SRAM). The cache 321 may determine whether data corresponding to both the process ID PID and the virtual address VA exists in the cache 321 and may generate a cache hit or a cache miss according to a result of the determination.

When a cache hit occurs, the S/W MMU 323A executing in the memory controller 320A during a read operation may not access either of the memory devices 330 and 340, but may transmit data DATA (e.g., DATA0, DATA3, or DATA5, etc.) corresponding to the process ID PID (e.g., PID1, PID3, or PID5, etc.) and the virtual address VA (e.g., VA1, VA3, or VA5, etc.) to the processor 210 of the host 200 through the memory interface 310.

When a cache miss occurs, the S/W MMU 323A may translate the process ID PID and the virtual address VA into the physical address PA or physical page number PPN using (or referring to) the virtual address-to-physical address translation map 327.

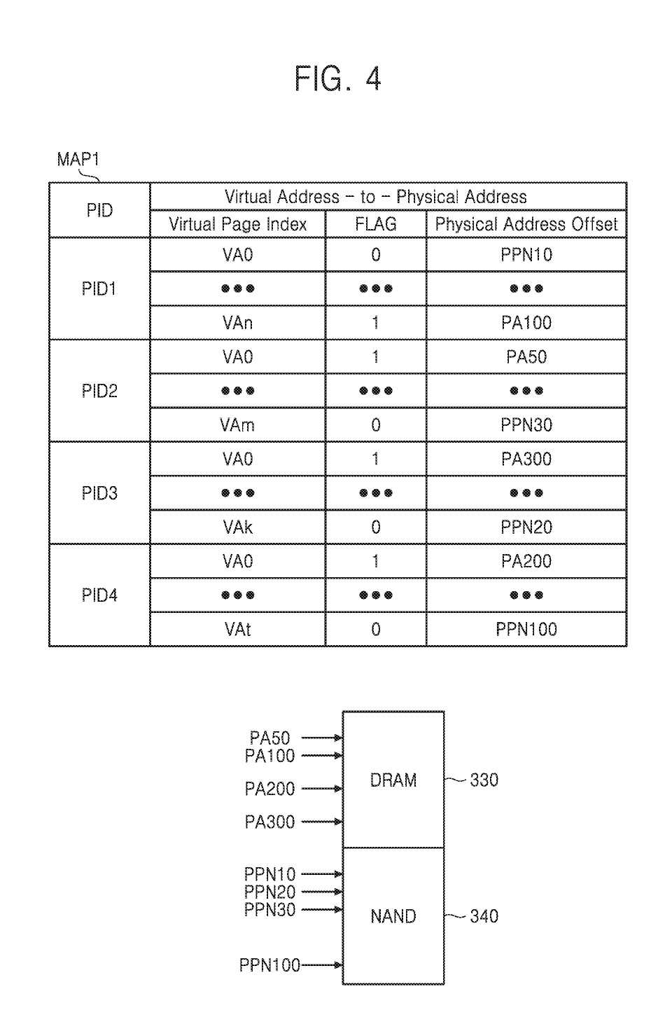

FIG. 4 is a diagram of a virtual address-to-physical address translation map stored in the memory system illustrated in FIG. 1 or 2 according to some example embodiments of the inventive concepts. As an example, referring to FIGS. 1 and 4, when it is assumed that the process ID PID is PID1 and the virtual address VA (or virtual page index) is VA0, the physical address corresponds to a physical address offset PPN10 of the second memory device 340. The physical address offset PPN10 corresponds to a start address of the memory operation. It is also assumed that when the process ID PID is PID1 and the virtual address VA (or virtual page index) is VAn, the physical address corresponds to a physical address offset PA100 of the first memory device 330. However, the example embodiments are not limited thereto and the table values in FIG. 4 are presented for illustrative purposes only.

A flag is an indicator bit (or indicator bits) that indicates which memory device, e.g., the first memory device 330 or the second memory device 340, etc., has been selected. For example, if the flag has a first bit value (e.g., 0) then the second memory device 340 has been selected, and if the flag has a second bit value (e.g., 1) then the first memory device 330 has been selected. If the number of memory devices is greater than 2, then the number of indicator bits comprising the flag increases accordingly (e.g., if the number of memory devices is 3 or 4, then the flag is 2 bits, etc.). The number of virtual addresses (or virtual page indexes) corresponding to each of the process IDs PID1 through PID4 illustrated in FIG. 4 may be the same or different among the process IDs PID1 through PID4. In FIG. 4, “n”, “m”, “k”, and “t” are natural numbers of at least 1.

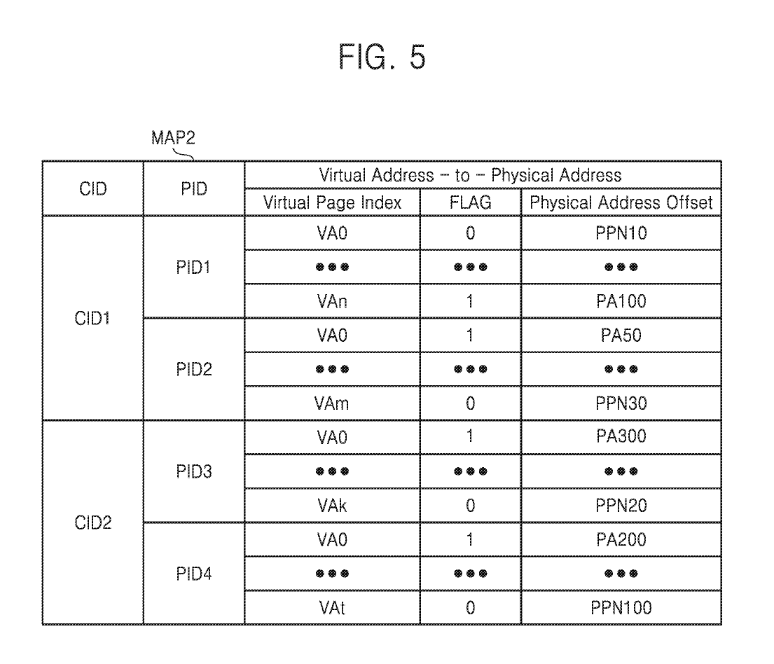

FIG. 5 is a diagram of a virtual address-to-physical address translation map stored in memory illustrated in FIG. 1 or 2 according to other example embodiments of the inventive concepts. The virtual address-to-physical address translation map 327 (e.g., MAP2) stored in the buffer memory device 325 includes a core ID CID of the processor 210 of the host 200. When the processor 210 includes a plurality of the cores (e.g., cores 211 and 213), the core ID CID is an identifier for identifying each of the cores (such as cores 211 and 213). For example, a first core ID CID1 indicates the first core 211 and a second core ID CID2 indicates the second core 213, but the example embodiments are not limited thereto and may include a different numbers of cores and core IDs.

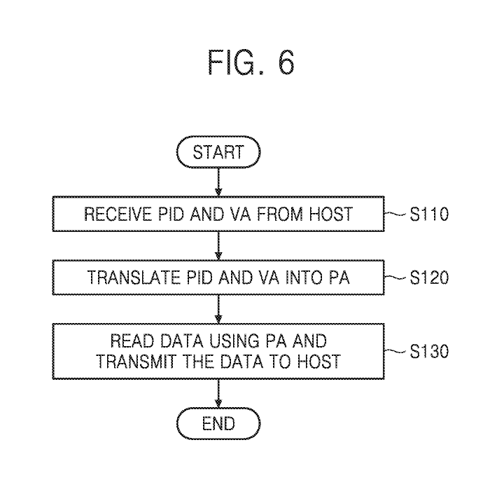

FIG. 6 is a flowchart of a read operation of the data storage device illustrated in FIG. 1 or 2 according to some example embodiments of the inventive concepts. The read operation of the data storage device 300A or 300B will be described with reference to FIGS. 1, 2, 4, and 6, but is not limited thereto. When the first process ID PID1 and the virtual address VA0 are provided by the host 200 in operation S110 for the read operation, a cache miss occurs in the memory controller 320A because the data corresponding to both the first process ID PID1 and the virtual address VA0 does not exist in the cache 321 as shown in FIG. 6. The S/W MMU 323A then translates the first process ID PID1 and the virtual address VA0 into the physical address PPN10 of the second memory device 340 using the virtual address-to-physical address translation map 327 (=MAP1) in operation S120.

The first selector circuit 324A transmits the physical address PPN (e.g., PPN10) to the second memory device 340 in response to the flag having the first bit value, or in other words, the first selector circuit 324A transmits the physical address PPN to at least one of the memory devices based on the flag value. The DMA controller 350 reads the data DATA2 stored in a memory region corresponding to the physical address PPN (e.g., PPN10) and transmits the data DATA2 to the host 200 through the memory interface 310 in operation S130.

In operation S110, for a read operation the process ID and the virtual address, e.g., first process ID PID1 and the virtual address Van, are provided by the host 200. As illustrated in FIG. 6, for example, a cache miss occurs in the memory controller 320A because the data corresponding to both the first process ID PID1 and the virtual address VAn does not exist in the cache 321 in this example. In operation S120, the S/W MMU 323A translates the first process ID PID1 and the virtual address VAn into the physical address PA100 using the virtual address-to-physical address translation map 327 (e.g., MAP1) in response to a cache miss.

In response to a flag having a second bit value, the first selector circuit 324A transmits the physical address PA100 to the first memory device 330. The DMA controller 350 reads the data DATA1 stored in a memory region corresponding to the physical address PA (e.g., PA100) and transmits the data DATA1 to the host 200 through the memory interface 310 in operation S130.

Continuously, when the second process ID PID2 and the virtual address VA0 are provided by the host 200 in operation S110 for the read operation, a cache miss occurs in the memory controller 320A because the data corresponding to both the second process ID PID2 and the virtual address VA0 does not exist in the cache 321. The S/W MMU 323A then translates the second process ID PID2 and the virtual address VA0 into the physical address PA50 of the first memory device 330 using the virtual address-to-physical address translation map 327 (e.g., MAP1) in operation S120.

The first selector circuit 324A transmits the physical address PA (e.g., PA50) to the first memory device 330 in response to a flag having the second bit value. The DMA controller 350 reads the data stored in a memory region corresponding to the physical address PA (e.g., PA50) and transmits the data to the host 200 through the memory interface 310 in operation S130.

When the second process ID PID2 and the virtual address VAm are provided by the host 200 in operation S110 for the read operation, a cache miss occurs in the memory controller 320A because the data corresponding to both the second process ID PID2 and the virtual address VAm does not exist in the cache 321 according to the example table illustrated in FIG. 4. The S/W MMU 323A translates the second process ID PID2 and the virtual address VAm into the physical address PPN30 using the virtual address-to-physical address translation map 327 (e.g., MAP1) in operation S120.

The first selector circuit 324A then transmits the physical address PPN (e.g., PPN30) to the second memory device 340 in response to a flag having the first bit value. The DMA controller 350 reads the data stored in a memory region corresponding to the physical address PPN (e.g., PPN30) and transmits the data to the host 200 through the memory interface 310 in operation S130.

As shown in FIG. 4, when the first process ID PID1 is different from the second process ID PID2, even if the virtual addresses VA0 are the same, the memory device 330 or 340 to be accessed for the read operation is different.

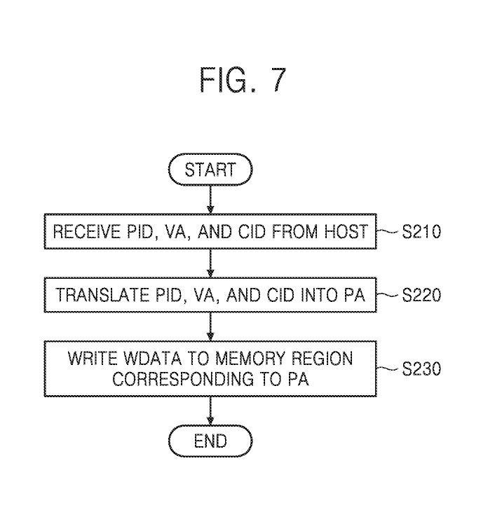

FIG. 7 is a flowchart of a read operation of the data storage device illustrated in FIG. 1 or 2 according to other example embodiments of the inventive concepts. The read operation of the data storage device 300A or 300B in case of a cache miss will be described in detail with reference to FIGS. 1, 2, 5, and 7.

When the first core ID CID1, the first process ID PID1, and the virtual address VA0 are provided by the host 200 in operation S210 for the read operation, the MMU 323A or 323B translates the first core ID CID1, the first process ID PID1, and the virtual address VA0 into the physical address PPN10 using the virtual address-to-physical address translation map 327 (e.g., MAP2) in operation S220.

The first selector circuit 324A transmits the physical address PPN (e.g., PPN10) to the second memory device 340 in response to a flag having the first bit value. In other words, the first selector circuit 324A transmits the physical address PPN to at least one of the memory devices based on the flag value. The DMA controller 350 reads data stored in a memory region corresponding to the physical address PPN (e.g., PPN10) and transmits the data to the host 200 through the memory interface 310 in operation S230.

When the second core ID CID2, the third process ID PID3, and the virtual address VA0 are provided by the host 200 in operation S210 for the read operation, the MMU 323A or 323B translates the second core ID CID2, the third process ID PID3, and the virtual address VA0 into the physical address PA300 using the virtual address-to-physical address translation map 327 (e.g., MAP2) in operation S220.

The first selector circuit 324A transmits the physical address PA (e.g., PA300) to the first memory device 330 in response to a flag having the second bit value. The DMA controller 350 reads data stored in a memory region corresponding to the physical address PA (e.g., PA300) and transmits the data to the host 200 through the memory interface 310 in operation S230.

When the first core ID CID1, the first process ID PID1, and the virtual address VA0 are provided by the host 200 in operation S210 in an example where the third process ID PID3 is the same as the first process ID PID1, the MMU 323A or 323B translates the first core ID CID1, the first process ID PID1, and the virtual address VA0 into the physical address PPN10 of the second memory device 340 in operation S220. However, when the second core ID CID2, the third process ID PID3 (e.g., PID1), and the virtual address VA0 are provided by the host 200 in operation S210, the MMU 323A or 323B translates the second core ID CID2, the third process ID PID3 (e.g., PID1), and the virtual address VA0 into the physical address PA300 of the first memory device 330 in operation S220 according to the example table illustrated in FIG. 5, but the example embodiments are not limited thereto. For example, the table illustrated in FIG. 5 may have other values populating the fields.

As described above, when the core IDs CID1 and CID2 are different from each other although the process IDs PID1 and PID3 are the same and the virtual addresses VA0 are the same, the physical addresses PPN10 and PA300 are different from each other according to the core IDs CID1 and CID2 according to at least one example embodiment, but the example embodiments are not limited thereto.

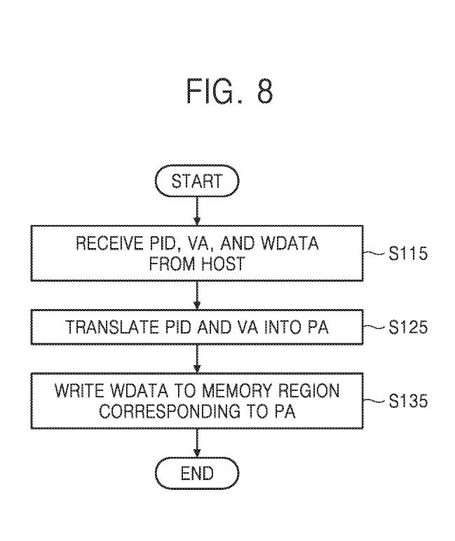

FIG. 8 is a flowchart of a write operation of the data storage device illustrated in FIG. 1 or 2 according to some example embodiments of the inventive concepts. The write operation of the data storage device 300A or 300B will be described with reference to FIGS. 1, 2, 4, and 8.

If a cache hit occurs or the cache 321 is not full during the write operation, the MMU (e.g., MMU 323A or 323B) may write the data WDATA received from the host 200 to the cache 321 instead of a memory region of the memory device 330 or 340 designated by the physical address PA or physical page number PPN to which the process ID PID and the virtual address VA received from the host 200 are mapped.

When the third process ID PID3, the virtual address VA0, and the data WDATA are provided by the host 200 in operation S115 for the write operation, the S/W MMU 323A translates the third process ID PID3 and the virtual address VA0 into a physical address PA300 using the virtual address-to-physical address translation map 327 (e.g., MAP1) if a cache miss occurs in operation S125.

The second selector circuit 324B writes the data WDATA to a memory region of the first memory device 330 corresponding to the physical address PA (e.g., PA300) in response to a flag having the second bit value (or in other words, the second selector circuit 324B writes data to a memory region of at least one of the memory devices based on the flag value) in operation S135.

When the fourth process ID PID4, the virtual address VAt, and the data WDATA are provided by the host 200 in operation S115 for the write operation, the S/W MMU 323A translates the fourth process ID PID4 and the virtual address VAt into a physical address PPN100 using the virtual address-to-physical address translation map 327 (e.g., MAP1) if a cache miss occurs in operation S125.

The second selector circuit 324B writes the data WDATA to a memory region of the second memory device 340 corresponding to the physical address PPN (e.g., PPN100) in response to a flag having the first bit value in operation S135.

According to at least one example embodiment, the read or write speed of the first memory device 330 may be faster than that of the second memory device 340, or vice versa. In other words, the hardware characteristics, performance characteristics, maintenance characteristics, cost characteristics, etc., of the plurality of memory devices may be heterogeneous, or not uniform. For example, the read latency of the first memory device 330 may be less than that of the second memory device 340. As another example, the first memory device 330 may be implemented as a volatile memory device and the second memory device 340 may be implemented as a non-volatile memory device. As a further example, the first memory device 330 may be a memory device that consumes more energy than the second memory device 340, etc.

A volatile memory device may be formed of RAM or dynamic RAM (DRAM), etc. A non-volatile memory device may be formed of flash memory, electrically erasable programmable read-only memory (EEPROM), magnetic RAM (MRAM), spin-transfer torque MRAM, ferroelectric RAM (FeRAM), phase-change RAM (PRAM), resistive RAM (RRAM), etc.

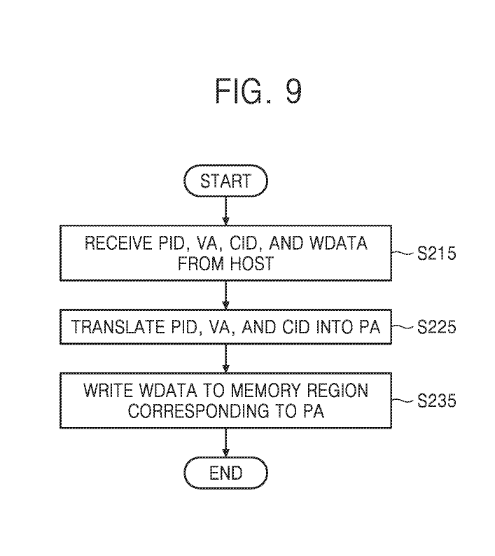

FIG. 9 is a flowchart of a write operation of the data storage device illustrated in FIG. 1 or 2 according to other example embodiments of the inventive concepts. The write operation of the data storage device 300A or 300B in case of a cache miss will be described in detail with reference to FIGS. 1, 2, 5, and 9.

When the first core ID CID1, the second process ID PID2, the virtual address VAm, and the data WDATA are provided by the host 200 in operation S215 for the write operation, the MMU 323A or 323B translates the first core ID CID1, the second process ID PID2, and the virtual address VAm into the physical address PPN30 of the second memory device 340 using the virtual address-to-physical address translation map 327 (e.g., MAP2) in operation S225.

The second selector circuit 324B writes the data WDATA to a memory region corresponding to the physical address PPN (e.g., PPN30) of the second memory device 340 in response to a flag having the first bit value in operation S235.

When the second core ID CID2, the third process ID PID3, the virtual address VAk, and the data WDATA are provided by the host 200 in operation S215 for the write operation, the MMU 323A or 323B translates the second core ID CID2, the third process ID PID3, and the virtual address VAk into a physical address PPN20 using the virtual address-to-physical address translation map 327 (e.g., MAP2) in operation S225.

The second selector circuit 324B writes the data WDATA to a memory region of the second memory device 340 corresponding to the physical address PPN (e.g., PPN20) in response to a flag having the first bit value in operation S235.

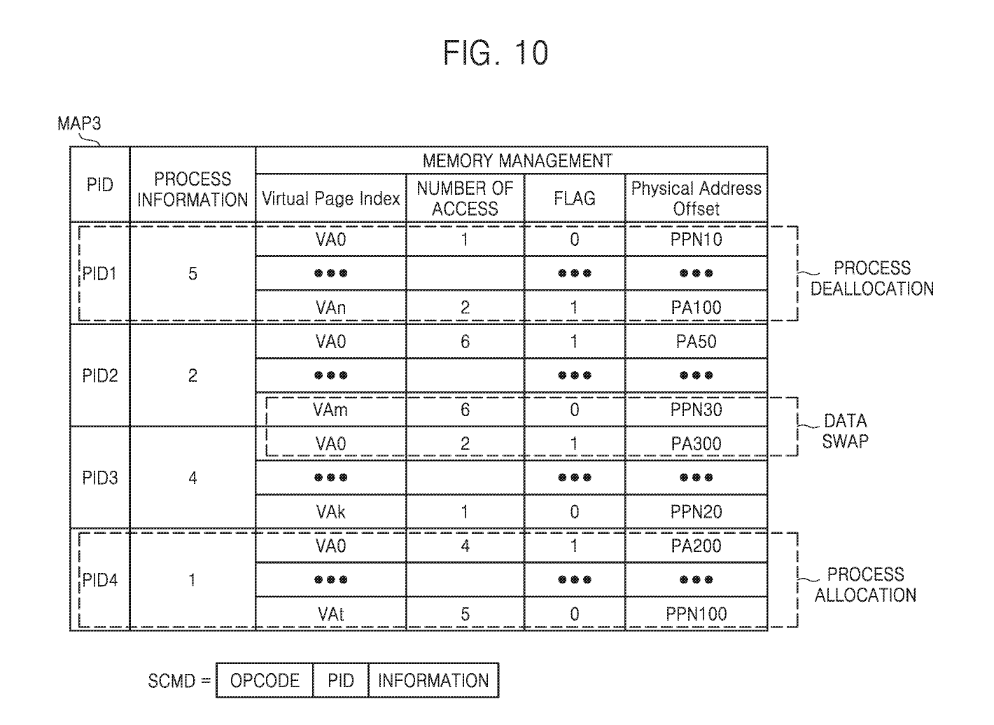

FIG. 10 is a conceptual diagram of the memory management of the data storage device illustrated in FIG. 1 or 2 according to some example embodiments of the inventive concepts. Referring to FIG. 10, a third map MAP3 is used for the memory management and may be stored in the buffer memory device 325 according to at least one example embodiment. Differently from the first map MAP1 illustrated in FIG. 4, the third map MAP3 illustrated in FIG. 10 further includes process information PROCESS INFORMATION and the number of accesses NUMBER OF ACCESS, but is not limited thereto.

According to at least one example embodiment, tt is assumed that a command SCMD provided by the processor 210 includes an operation code OPCODE, the process ID PID, and information INFORMATION, but the example embodiments are not limited thereto. The operation code OPCODE includes bits describing or indicating a type of the command SCMD. The process ID PID includes a process ID that is the object of the command SCMD.

For example, when the operation code OPCODE includes bits that describe a process deallocation operation PROCESS DEALLOCATION, and when the process ID PID is the first process ID PID1, the MMU 323A or 323B of the data storage device 300A or 300B may perform the process deallocation operation PROCESS DEALLOCATION on the first process ID PID1. The process deallocation operation PROCESS DEALLOACATION may include memory deallocation for each of the memory devices 330 and 340.

As another example, when the operation code OPCODE includes bits describing a process allocation operation PROCESS ALLOCATION and the process ID PID is the fourth process ID PID4, the MMU 323A or 323B of the data storage device 300A or 300B may perform the process allocation operation PROCESS ALLOCATION on the fourth process ID PID4. The process allocation operation PROCESS ALLOCATION may include memory allocation for each of the plurality of memory devices, e.g., memory devices 330 and 340.

As a further example, when the operation code OPCODE includes bits describing a data swap operation DATA SWAP and the process ID PID includes the second process ID PID2 and the third process ID PID3, the information INFORMATION may include information for the position and/or size of data to be swapped. When the operation code OPCODE includes bits describing priority, the process ID PID may include the second process ID PID2 and the third process ID PID3.

Additionally, the MMU 323A or 323B may generate process information PROCESS INFORMATION and the number of accesses NUMBER OF ACCESS in response to (and/or based on) the command SCMD. The process information PROCESS INFORMATION may be generated for each process ID PID and may be information corresponding to the operation code OPCODE. The process deallocation operation PROCESS DEALLOCATION may be represented (and/or stored) as a desired numeral (e.g., “5”) in the process information PROCESS INFORMATION. The process allocation operation PROCESS ALLOCATION may be represented (and/or stored) as a second desired numeral (e.g., “1”) in the process information PROCESS INFORMATION. The data swap operation DATA SWAP may be represented (and/or stored) as one or more numerals (e.g., “2” or “4”) in the process information PROCESS INFORMATION. However, the numerals presented as the process information PROCESS INFORMATION in the third map MAP3 are just examples and the numeral representations are not limited thereto.

According to at least one example embodiment, the number of accesses NUMBER OF ACCESS may be generated for each virtual addresses, for example, VA0 through VAn, VA0 through VAm, VA0 through VAk, and VA0 through VAt. For example, the number of accesses NUMBER OF ACCESS may indicate the number of accesses made by the MMU 323A or 323B to either of the memory devices 330 and 340 for the read or write operation.

For the data swap DATA SWAP, for example, the MMU 323A or 323B may move data stored in a first memory region of the first memory device 330 corresponding to a first physical address (e.g., PA300) to a second memory region corresponding to a second physical address (e.g., PPN30) or may swap the data stored in the first memory region and the data stored in the second memory region. The data swap DATA SWAP may be performed by the DMA controller 350 according to the control of the MMU (e.g., MMU 323A or 323B) according to at least one example embodiment.

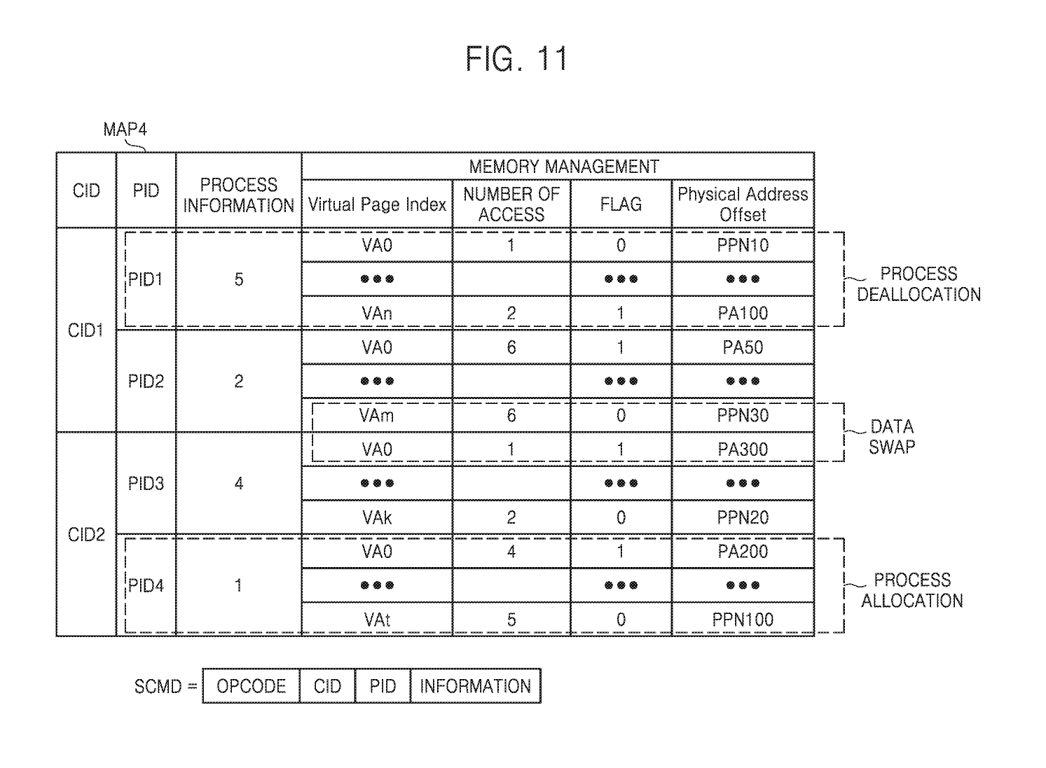

FIG. 11 is a conceptual diagram of the memory management of the data storage device illustrated in FIG. 1 or 2 according to other example embodiments of the inventive concepts. Referring to FIG. 11, a fourth map MAP4 is used for the memory management and may be stored in a buffer memory device 325. Differently from the second map MAP2 illustrated in FIG. 5, the fourth map MAP4 illustrated in FIG. 11 further includes process information PROCESS INFORMATION and the number of accesses NUMBER OF ACCESS, but is not limited thereto.

According to at least one example embodiment it is assumed that the command SCMD provided by the processor 210 includes the operation code OPCODE, the core ID CID, the process ID PID, and the information INFORMATION, but the example embodiments are not limited thereto. The operation code OPCODE includes bits describing or indicating a type of the command SCMD. The core ID CID includes a core ID that is the object of the command SCMD.

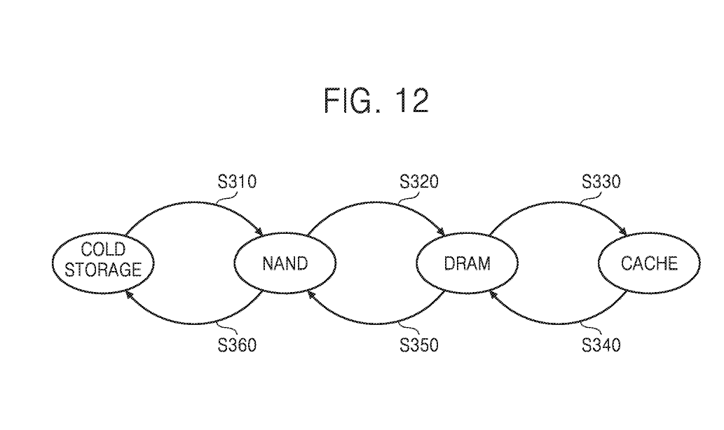

FIG. 12 is a conceptual diagram for explaining hierarchical memory shift in accordance with a data usage level for locality according to at least one example embodiment. Referring to FIGS. 1, 2, and 12, data stored in a cold storage COLD STORAGE is moved to a second memory device NAND in operation S310, or is swapped for data stored in the second memory device NAND in operations S310 and S360 according to the use frequency of the data, or whether storage space of the memory device storing the data is full.

The data stored in the second memory device NAND is moved to a first memory device DRAM in operation S320, or is swapped for data stored in the first memory device DRAM in operations S320 and S350 according to the use frequency of the data or whether storage space of the memory device storing the data is full according to at least one example embodiment.

The data stored in the first memory device DRAM is moved to a cache CACHE in operation S330, or is swapped for data stored in the cache CACHE in operations S330 and S340, according to the use frequency of the data or whether storage space of the memory device storing the data is full according to at least one example embodiment. The second memory device NAND refers to the second memory device 340, the first memory device DRAM refers to the first memory device 330, and the cache CACHE refers to the cache 321, but the example embodiments are not limited thereto and the first memory device, and the second memory device, and the third memory device (e.g., cache) may be other types of memory devices. Further, the example embodiments are not limited to only three memory devices and may include a greater or lesser number of memory devices.

When the cache CACHE is full, the MMU 323A or 323B moves data stored in the cache CACHE to the first memory device DRAM. When there is a read request from the host 200, the MMU 323A or 323B moves data stored in the first memory device DRAM to the cache CACHE.

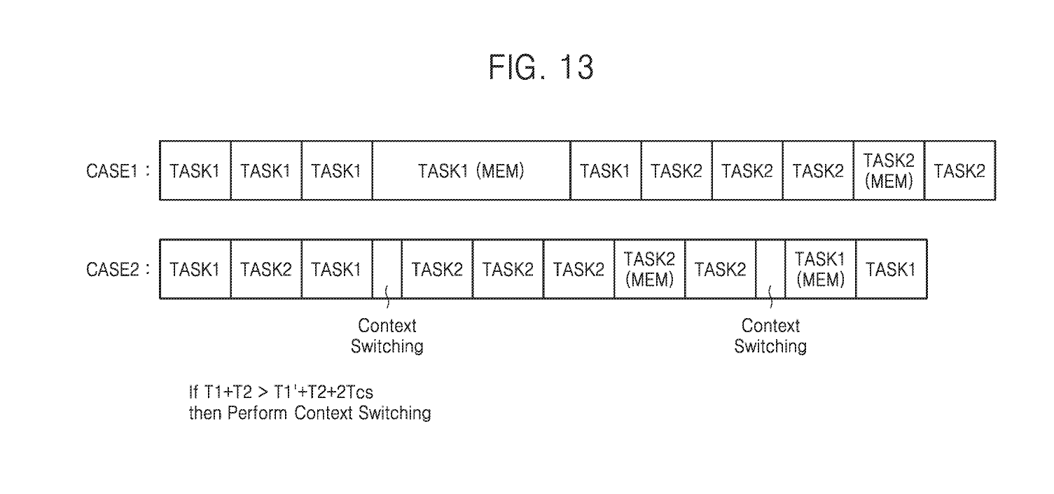

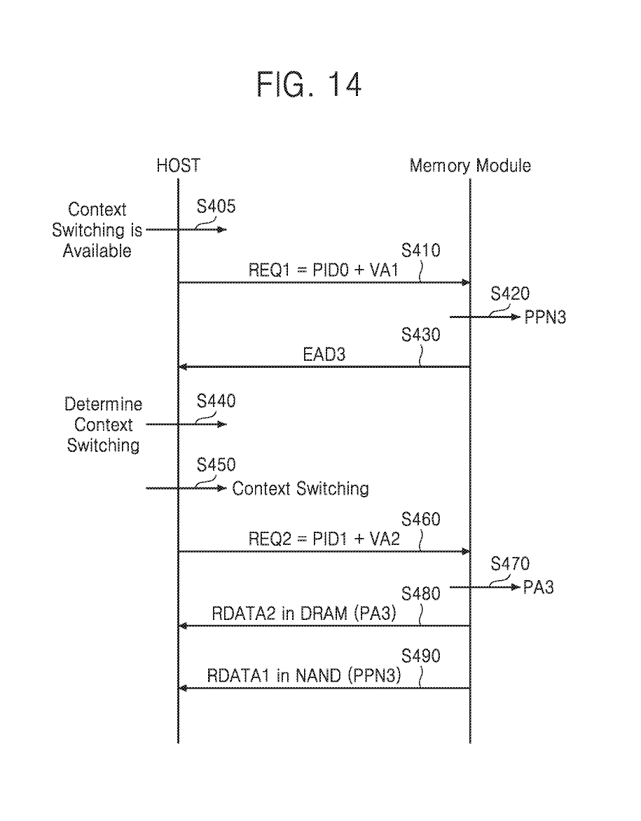

FIG. 13 is a conceptual diagram for explaining context switching according to some example embodiments of the inventive concepts. FIG. 14 is a conceptual diagram of the operation of the data processing system, illustrated in FIG. 1 or 2, which performs the context switching illustrated in FIG. 13, according to some example embodiments of the inventive concepts. Referring to FIGS. 1, 2, 13, and 14, a first case CASE1 shows a time for which each task is performed when the context switching is not performed and a second case CASE2 shows a time for which each task is performed when the context switching is performed, but the example embodiments are not limited thereto.

The processor 210 of the host 200 sends a first request REQ1 to the data storage device (e.g., data storage device 300A or 300B, collectively denoted by reference numeral 300) in operation S410. The first request REQ1 includes the process ID (e.g., PID0) and the virtual address (e.g., VA1). The MMU (e.g., MMU 323A or 323B) reads the virtual address-to-physical address translation map (e.g., map 327) stored in the buffer memory device 325 and translates the process ID (e.g., PID0) and the virtual address (e.g., VA1) into the physical address PPN3 of a memory device, such as the second memory device 340, using the virtual address-to-physical address translation map (e.g., map 327) in operation S420. The MMU (e.g., MMU 323A or 323B) calculates an access delay DL (e.g., EAD3) necessary to perform a read operation with respect to the physical address PPN3 and sends the access delay DL (e.g., EAD3) to the host 200 in operation S430.

The processor 210, for example the first core 211, of the host 200 determines whether to perform context switching in operation S440. For example, when the sum of a time T2 taken to perform five second tasks and a time T1 taken to perform five first tasks before the context switching is greater than the sum of the time T2 taken to perform five second tasks and a time T1′ taken to perform five first tasks after the context switching, the processor 210 (e.g. the first core 211) performs the context switching in operation S450.

As a result of the context switching, the processor 210 of the host 200 sends a second request REQ2 to the data storage device (e.g., data storage device 300A or 300B) in operation S460. The second request REQ2 includes the process ID (e.g., PID1) and the virtual address (e.g., VA2). The MMU (e.g., MMU 323A or 323B) reads the virtual address-to-physical address translation map (e.g., map 327) stored in the buffer memory device (e.g., 325) and translates the process ID (e.g., PID1) and the virtual address (e.g., VA2) into the physical address PA3 of a memory device (e.g., the first memory device 330) using the virtual address-to-physical address translation map (e.g., map 327) in operation S470. The MMU (e.g., MMU 323A or 323B) transmits data RDATA2 stored in the memory device (e.g., first memory device 330) corresponding to the physical address PA3 to the host 200 in operation S480. Thereafter, the MMU (e.g., MMU 323A or 323B) transmits data RDATA1 stored in the memory device (e.g., second memory device 340) corresponding to the physical address PPN3 to the host 200 in operation S490. In FIG. 13, a reference character “Tcs” denotes a time necessary for the context switching.

As another example, a fourth task TASK1 (MEM) in a first thread including five first tasks TASK1 is to access the second memory device 340. A fourth task TASK2 (MEM) in a second thread including five second tasks TASK2 is to access the first memory device 330.

Referring to the second case CASE2, a total time taken to perform the first and second threads is reduced even though context switching is performed two times.

As described above, according to some example embodiments of the inventive concepts, a data storage device including an MMU and heterogeneous memory devices receives a virtual address instead of a physical address from a host and accesses either of the heterogeneous memory devices using the virtual address. Since the data storage device accesses the heterogeneous memory devices using the virtual address provided by the host, the overhead of virtual address-to-physical address translation in the host is reduced.

In addition, the data storage device performs memory allocation and memory deallocation according to a process by itself, so that the load of an OS run in the host is reduced. The data storage device also reduces the number of accesses to a memory device in case of a translation lookaside buffer (TLB) miss, thereby reducing data latency.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

As is traditional in the field of the inventive concepts, various example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar processing devices, they may be programmed using software (e.g., microcode) to perform various functions discussed herein and may optionally be driven by firmware and/or software, thereby transforming the microprocessor or similar processing devices into a special purpose processor. Additionally, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the inventive concepts. Further, the blocks, units and/or modules of the embodiments may be physically combined into more complex blocks, units and/or modules without departing from the scope of the inventive concepts.

1. A method of operating a data storage device, the data storage device including a first memory device, a second memory device, and a third memory device storing a translation map, the method comprising:
receiving, an identifier and a virtual address from a host, the identifier being one of a first ID and a second ID;
selecting one of a first physical address and a second physical address using the translation map based on the received identifier and the virtual address,
the translation map including first information related to a mapping of the first ID and the virtual address to the first physical address of the first memory device, and second information about a mapping of the second ID and the virtual address to the second physical address of the second memory device; and
reading data from one of the first memory device and the second memory device based on the selected physical address; and
transmitting the read data to the host.

2. The method of claim 1, wherein
the first ID is a first process ID of a first process executed in a processor of the host; and
the second ID is a second process ID of a second process executed in the processor.

3. The method of claim 1, wherein
when the host includes at least one multi-core processor including a first core and a second core,
the first ID includes a first core ID of the first core and a process ID, and
the second ID includes a second core ID of the second core and the process ID; and
the process ID indicates a process executed in either of the first core and the second core.

4. The method of claim 1, wherein the data storage device is a dual in-line memory module.

5. A method of operating a data storage device including a first memory device and a second memory device, the method comprising:
receiving a first identifier (ID) and a virtual address from a host;
translating the first ID and the virtual address into a first physical address; and
accessing at least one of the first memory device and the second memory device based on the first physical address.

6. The method of claim 5, wherein the translating the first ID and the virtual address into the first physical address comprises:
translating the first ID and the virtual address into the first physical address based on a bit value of a flag which identifies at least one of the first memory device or the second memory device.

7. The method of claim 6, further comprising:
reading first data from the accessed memory device corresponding to the first physical address; and
transmitting the first data to the host.

8. The method of claim 5, further comprising:
receiving a second ID and the virtual address from the host;
translating the second ID and the virtual address into a second physical address; and
accessing at least one of the first memory device and the second memory device based on the second physical address.

9. The method of claim 8, wherein the translating the second ID and the virtual address into the second physical address comprises:
translating the second ID and the virtual address into the second physical address based on a bit value of a flag which identifies at least one of the first memory device or the second memory device.

10. The method of claim 9, further comprising:
reading second data from the second accessed memory device based on the second physical address; and
transmitting the second data to the host.

11. The method of claim 5, wherein
the first memory device has a first read latency; and
the second memory device has a second read latency, the second read latency being different from the first read latency.

12. The method of claim 5, further comprising:
calculating an access delay with respect to a region corresponding to the first physical address; and
transmitting the access delay to the host.

13. The method of claim 8, wherein
the first ID is an ID of a first process executed in at least one processor of the host; and
the second ID is an ID of a second process executed in the processor.

14. The method of claim 8, wherein
when the host comprises a multi-core processor including at least a first core and a second core, the first ID is a ID of the first core and the second ID is a ID of the second core.

15. The method of claim 8, wherein when the host comprises a multi-core processor including at least a first core and a second core:
the first ID includes a ID of the first core and a process ID; and
the second ID includes a second core ID of the second core and the process ID; and
the process ID indicates a process executed in either of the first core and the second core.

16. The method of claim 8, wherein the first ID and the second ID are received through a dedicated pin formed in the data storage device.

17-20. (canceled)

21. A method for operating a data storage device, the data storage device including a plurality of heterogeneous memory devices and a memory controller, the method comprising:
receiving, using the memory controller, a memory operation instruction from a host, the memory operation including at least a process ID and a virtual address;
translating, using the memory controller, the virtual address into a physical address associated with a memory device of the plurality of heterogeneous memory devices using a virtual address-to-physical address translation map stored on a buffer and the process ID; and
performing, using the memory controller, a memory operation at the physical address on the associated memory device in accordance with the memory operation instruction.

22. The method of claim 21, wherein
the virtual address is a virtual page number; and
the physical address is a physical page number.

23. The method of claim 21, wherein the translating further includes:
determining, using the memory controller, a value of a flag of the virtual address-to-physical address translation map, the flag value indicating the memory device of the plurality of heterogeneous memory devices.

24. The method of claim 21, wherein each of the plurality of heterogeneous memory devices has different performance characteristics than the other memory devices of the plurality of heterogeneous memory devices.
